(19) United States
(12) Patent Application Publication
(10) Pub. No.: US 2013/0193154 A1
(43) Pub. Date: Aug. 1, 2013

(54) RETRACTION CORD DISPENSER

(71) Applicants: Scott Eric Moore, Bountiful, UT (US); Wade J. Cannon, Orem, UT (US)

(72) Inventors: Scott Eric Moore, Bountiful, UT (US); Wade J. Cannon, Orem, UT (US)

(73) Assignee: Ultradent Products, Inc., South Jordan, UT (US)

(21) Appl. No.: 13/564,974

(22) Filed: Aug. 2, 2012

Related U.S. Application Data
(60) Provisional application No. 61/514,228, filed on Aug. 2, 2011.

(51) Int. Cl. A61C 9/00

(52) U.S. Cl. CPC A61C 9/0033
USPC 221/1; 221/26; 221/30

(57) ABSTRACT

A retraction cord dispenser can comprise a container with an open end and can be configured to hold retraction cord. The dispenser also includes a dispenser cap for attachment to the open end, and comprises a cap body with a narrow passage for dispensing retraction cord from the container, and the narrow passage can be associated with a retention flap to prevent retraction cord from re-entering the container once it has been dispensed.

This application claims the benefit of U.S. Provisional Patent Application No. 61/514,228, filed Aug. 2, 2011.

### BACKGROUND

Gingival retraction cord is used to retract the gum tissue from the tooth structure to temporarily displace the gum tissue for various purposes. In one example, the gum tissue is retracted from the tooth structure so that an accurate impression of the teeth can be made in preparation for a crown, bridge, implant, etc. Thus, when the crown, bridge, implant, or other structure is permanently installed in the mouth, the structure will more accurately fit the tooth or teeth without leaving an unwanted void at the margin.

For some procedures, multiple short lengths of retraction cord are often needed by the dental professional in relatively rapid succession. This can be problematic since it is usually supplied in the form of a mass or coil. Thus, dispensing devices of various types have been developed which are used for the convenience of dental professionals. These devices often allow for customized retraction cord length dispensing, while preventing contamination of the coiled material prior to use. However, certain dispensing systems have their drawbacks and some improvement would be beneficial.

### SUMMARY

It has been recognized that many retraction cord dispensers available on the market have some basic usability problems that are addressed by embodiments of the present disclosure. Specifically, retraction cord dispensers are generally capable of dispensing and cutting desired lengths of retraction cord, but often have the problem of allowing retraction cord remaining with the dispenser (after removing the dispensed retraction cord) to fall in or be pulled back into its dispensing container. When this occurs, it is difficult for dental professionals to quickly retrieve retraction cord when needed. Furthermore, cutting in some circumstances can lead to a frayed end of the retraction cord, which can cause additional problems as it relates to normal use of the retraction cord.

In accordance with this, a retraction cord dispenser can comprise a container with an open end and configured to hold retraction cord, and a dispenser cap for attachment to the open end. The dispenser cap can include a cap body with a narrow passage for dispensing retraction cord from the container, and can also include a retention flap to prevent retraction cord from re-entering (e.g., falling back into the container or being pulled from within as the coil moves) the container once it has been dispensed.

In another embodiment, a retraction cord dispenser can comprise a container with an open end and configured to hold retraction cord, and a dispenser cap for attachment to the open end. The dispenser cap can include a cap body having a narrow passage through which the retraction cord is dispensed from the container and a cutting surface for working with a cutting blade to cut the dispensed retraction cord. The dispenser cap can also include a lid having a cutting device attached thereto. The cutting device can include an exposed blade configured to cut retraction cord when the cutting device is pressed against the cutting surface. The exposed blade can be positioned at an angle ranging from 2° to 15° with respect to the cutting surface when the lid is pressed into a closed position over the cap body.

A method of dispensing and cutting retraction cord is also disclosed which comprises multiple steps. For example, steps can include pulling retraction cord from a container through a narrow passage of a cap body, and cutting the retraction cord by closing a lid over the cap body. The lid is typically attached to the cap body and has an exposed blade affixed thereto that contacts or nearly contacts the cap body when the lid is in a closed configuration. An additional step can include engaging the retraction cord with a retention flap positioned within the narrow passage, thereby preventing a dispensing end of the retraction cord from re-entering the container through the narrow passage.

### DESCRIPTION OF THE DRAWINGS

FIG. 1 is an assembled retraction cord dispenser with retraction cord positioned therein in accordance with embodiments of the present disclosure;

FIG. 2 is a bottom plan view of a dispenser cap with the lid in an open position, taken along view A-A of FIG. 1, but without showing the retraction cord of FIG. 1, in accordance with embodiments of the present disclosure;

FIG. 3 is a top plan view of the dispenser cap with the lid in an open position, in accordance with embodiments of the present disclosure;

FIG. 4 is a detailed view of section B of FIG. 3, showing how the cutting device is gripped by the lid in accordance with embodiments of the present disclosure;

FIGS. 5a and 5b depict two alternatively examples of cutting device configurations, with views taken along section C-C of FIG. 3, in accordance with embodiments of the present disclosure;

FIGS. 5c-5e depict various alternative embodiments of cutting device configurations relative to cutting surfaces when a lid is in a closed position in accordance with embodiments of the present disclosure;

FIG. 6 is a cross-sectional view of a portion of an assembled retraction cord dispenser in accordance with embodiments of the present disclosure;

FIG. 7 is a cross-sectional view of FIG. 3, taken along section D-D, in accordance with embodiments of the present disclosure;

FIG. 8 is a top plan view of a narrow passage for dispensing retraction cord with a retention flap disposed therein, taken along view E-E of FIG. 7, in accordance with embodiments of the present disclosure;

FIG. 9 is a detailed view of section F of FIG. 7, showing where the cutting device is attached to the lid in accordance with embodiments of the present disclosure;

FIG. 10 is a cross-sectional view of a portion of a dispenser cap, similar to that shown in FIG. 7, except that the retention flap is in a different location within the narrow passage in accordance with embodiments of the present disclosure;

FIG. 11 is a top plan view of a narrow passage for dispensing retraction cord, which also shows the retention flap, taken along view G-G of FIG. 10, in accordance with embodiments of the present disclosure;

FIG. 12 is a cross-sectional view of a portion of a dispenser cap, similar to that shown in FIG. 7, except that the retention flap is of a different configuration in accordance with embodiments of the present disclosure; and FIGS. 13a and 13b are alternative top plan views of a narrow passage for dispensing retraction cord, each of which also shows alternative retention flaps, taken along view H-H of FIG. 12, in accordance with embodiments of the present disclosure.

### DETAILED DESCRIPTION

Reference will now be made to the exemplary embodiments and specific language will be used herein to describe the same. It will nevertheless be understood that no limitation of the scope of the invention is thereby intended. Alterations and further modifications of the inventive features illustrated herein, and additional applications of the principles of the disclosure as illustrated herein, which would occur to one skilled in the relevant art and having possession of this disclosure, are to be considered within the present scope. It is also to be understood that this invention is not limited to the particular configurations, process steps and materials disclosed herein as these may vary to some degree. Further, it is to be understood that the terminology used herein is used for the purpose of describing particular embodiments only, and is not intended to be limiting as the scope of the present invention.

A retraction cord dispenser in accordance with examples of the present disclosure can comprise a container with an open end and configured to hold retraction cord and a dispenser cap for attachment to the open end. The dispenser cap can include a cap body with narrow passage for dispensing retraction cord from the container, and also includes a retention flap to prevent retraction cord from re-entering the container once it has been dispensed. Optionally, the dispenser can also include a lid attached to the cap body, and can have an open position which exposes the narrow passage and a closed position which covers the open passage. A cutting device can also optionally be present on the lid and can be configured to cut retraction cord when the lid is transitioned from the open position to the closed position.

In certain specific embodiments, the retraction cord dispenser can be assembled with the retraction cord disposed within the container. For example, a dispensing end of the retraction cord can be dispensed through the narrow passage, the retention flap can be positioned to prevent the dispensing end of the retraction cord from re-entering the container, and the lid can be in the closed configuration. This will be the typical state of the dispenser after each use by the dental professional.

Regarding the retention flap, one of several configurations can be implemented in accordance with examples of the present disclosure. For example, the retention flap can be a single flap configured to hold the retraction cord in place against a wall of the narrow passage. Alternatively, the retention flap can be one of multiple flaps configured to hold the retraction cord therebetween, e.g., two opposing flaps within the narrow passage, three or more flaps with an interfacing position for the retraction cord to pass through, etc.

With specific reference to the cutting device, this can include an attachment end affixed to a lower surface of the lid, and an exposed blade. Thus, the attachment end of the blade can be affixed to the lower surface of the lid, and in this configuration, the blade can be positioned parallel to a cutting surface when the lid is in the closed position. Alternatively, the blade can be positioned at an angle ranging from 2° to 15° with respect to the cutting surface when the lid is in the closed position, e.g., the blade is angled and/or the cutting surface is angled so that the relative angle between the two structures ranges from 2° to 15°. In this latter configuration, there is less of a tendency for a freshly cut dispensing end of the retraction cord to fray. In either example however, in order to put pressure on the retraction cord so that the blade will cut the cord, the cap body typically includes a cutting surface which contacts or nearly contacts the blade when the lid is in the closed position.

In another embodiment, a retraction cord dispenser can comprise a container with an open end and configured to hold retraction cord, and a dispenser cap for attachment to the open end. The dispenser cap can include a cap body having a narrow passage for dispensing retraction cord from the container and a cutting surface for supporting dispensed retraction cord for cutting. The dispenser cap can also include a lid having a cutting device attached thereto. The cutting device can include an exposed blade configured to cut retraction cord when the cutting device is pressed against the cutting surface. The exposed blade can be positioned at an angle ranging from 2° to 15° with respect to the cutting surface when the lid is pressed into a closed position over the cap body.

In a specific embodiment, the cap body can further comprise a narrow passage including a retention flap to prevent retraction cord from re-entering the container once it has been dispensed. Regarding the angle between the exposed blade and the cutting surface, in one embodiment, the exposed blade can be parallel to an upper surface of the lid, and the cutting surface can be angled at from 2° to 15° with respect to the exposed blade when the lid is in the closed position. In another embodiment, the cutting surface can be parallel to an upper surface of the lid when the lid is in the closed position, and the exposed blade is angled at from 2° to 15° with respect to the cutting surface when the lid is in the closed position. Still further, both the exposed blade and the cutting surface can be at an angle (not parallel) to the lid when the lid is in the closed position, and the relative angle between the two structures can be from 2° to 15°.

Turning now to a method of dispensing and cutting retraction cord, as described herein, the method can comprise multiple steps. For example, steps can include pulling retraction cord from a container through a narrow passage of a cap body, and cutting the retraction cord by closing a lid over the cap body. The lid is typically attached to cap body and has an exposed blade affixed thereto that contacts or nearly contacts the cap body when the lid is in a closed configuration. An additional step can include engaging the retraction cord with a retention flap positioned within the narrow passage, thereby preventing a freshly cut dispensing end of the retraction cord from re-entering the container through the narrow passage.

Again, in this embodiment, the retention flap can a single flap configured to hold the retraction cord in place against a wall of the narrow passage, or can include multiple flaps configured to hold the retraction cord therebetween. Further, the step of cutting the retraction cord can include pushing the exposed blade through the retraction cord and against a cutting surface of the cap body. Upon closing the lid over the cap body, the exposed blade is positioned parallel to the cutting surface, or the exposed blade can be positioned at an angle ranging from 2° to 15° with respect to a cutting surface.

It is noted that the retraction cord dispensers of the present disclosure are appropriate for use with all types of gingival retraction cord, including braided cotton or polyester retraction cord of various diameters, pre-soaked or pre-impregnated retraction cord, including retraction cord pre-soaked with a hemostatic agent to prevent bleeding, or the like.

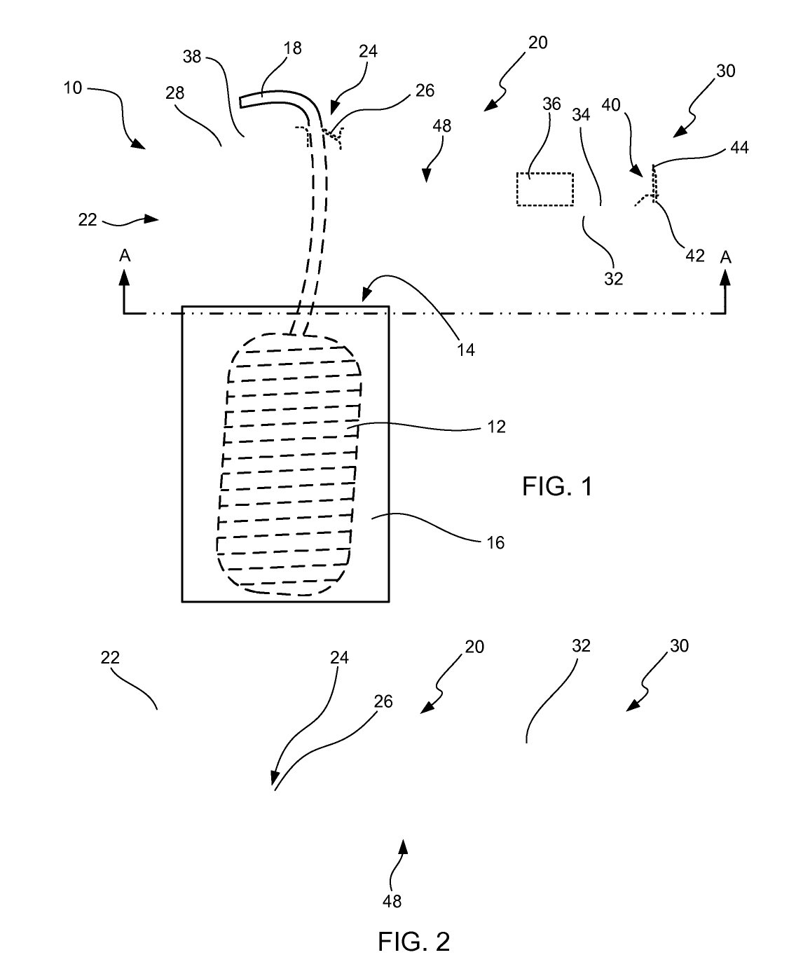

Turning now to the FIGS., more specific embodiments of the present disclose are shown by way of example. For example, in FIG. 1, an assembled retraction cord dispenser 10 is shown with retraction cord 16 in a container 12. The container includes an open end 14 for dispensing and cutting the retraction cord at its dispensing end 18. The dispenser also includes a dispenser cap 20 comprising a cap body 22, a lid 30, and a flexible attachment arm 48. The flexible attachment arm allows for the lid to remain attached as part of the dispenser cap, and is flexible for moving the lid from an open position (shown in FIG. 1) to a closed storage and retraction cord cutting position.

With specific reference to the cap body 22, the dispensing end 18 of the retraction cord 16 is passed through a narrow passage 24. A retention flap 26 is carried by the cap body (or is part of the cap body), and can be within the narrow passage. The retention flap is configured and positioned to prevent the dispensing end from inadvertently falling or being pulled back into the container 12. In other words, once dispensed, the retraction cord is held by the retention flap with enough force to prevent the retraction cord from becoming immediately inaccessible by a user. In other systems, when the retraction cord falls back or is pulled back into its storage container, the user then would have to remove its lid or other functional structure, rethread the retraction cord through the dispenser opening, pulling it through in preparation for further dispensing. This is inconvenient to the user, particularly when the user is working on a dental patient.

The lid 30 works together with the cap body 22 to providing both cutting and storage properties to the dispenser cap 20 as a whole. Specifically, the lid includes an upper surface 32, which forms the top of the dispenser cap when the flexible arm 48 is bent and the lid is in a closed position. The lid also includes a lower surface 34 that supports a cover 36 for the narrow passage, as well as a cutting device 40. The cutting device includes an attachment end 42 where it is generally attached to the lid, and an exposed blade 44 that is used to cut the retraction cord when the lid is closed on the cap body. Specifically, the exposed blade is configured to contact or nearly contact a cutting surface 28 of the cap body when the lid is in the closed position. In this manner, pressure can be placed on the dispensing end 18 of the retraction cord 16 for appropriate cutting. In further detail, also shown in this example is a retraction cord guide 38 which can be used to hold the retraction cord in place when the lid is closed over the retraction cord during the cutting process.

It is noted that the term “near” or “nearly” when it refers to contacting of the exposed blade with the cutting surface includes a proximity that is closer than the thickness of the retraction cord. Typically, the gap between the exposed blade and the cutting surface is significantly narrower than the thickness of the retraction cord, and often, there is contact between the exposed blade and the cutting surface after cutting of the retraction cord. It is also noted that the term “exposed blade” refers to the blade when the lid is in the open position. When the lid is in a closed position, the “exposed blade” is actually covered between the lid and the cap body.

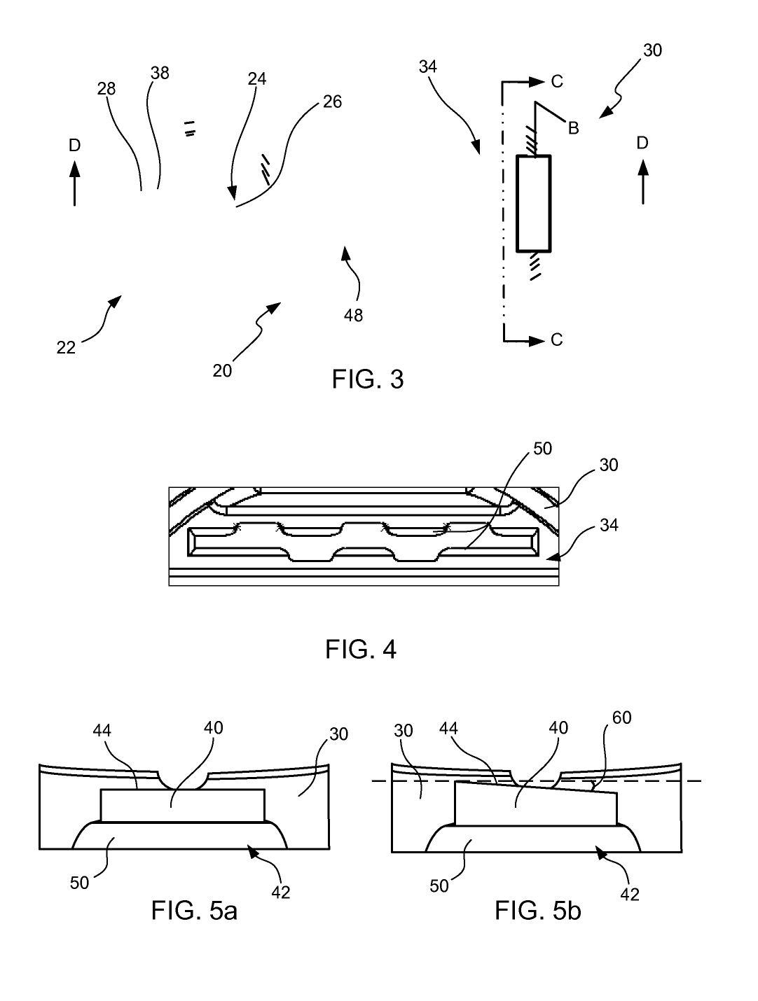

Referring now to FIGS. 2 and 3, further detail is provided as it relates to the dispenser cap 20. Specifically, FIG. 2 depicts a bottom view of the dispenser cap, taken along sectional view A-A of FIG. 1, and FIG. 3 is a top view of FIG. 1. In both of these views, the lid 30 is in the open configuration. Also shown is the cap body 22 attached to the lid via the flexible attachment arm 48. Narrow passage 24 and retention flap 26, as previously described, are present for passing retraction cord therethrough and retaining the retraction cord to prevent it from falling or being pulled back into the container (not shown). A cutting surface 28 and a retraction cord guide 38 are also shown as positioned on the cap body. It is noted that though FIG. 2 depicts a bottom view of the dispenser cap, the upper surface 32 of the lid is shown because the lid is in the open position. In the closed position, the upper surface of the lid would coincide and be visible with the top view of the dispenser cap. Likewise, though FIG. 3 depicts a top view of the dispenser cap, the lower surface 34 of the lid is shown because the lid is in the open position. In the closed position, the lower surface of the lid would coincide directionally with the bottom view.

FIG. 4 provides a detailed view of section B of FIG. 3, showing how a cutting device (not shown) can be held in place by the lid 30 in accordance with embodiments of the present disclosure. Specifically, the cutting device includes an attachment end which is attached to the lower surface 34 of the lid, and is held in place by a mechanical grip 50. Alternatively or additionally, the attachment end of the cutting device can be held intact at the lower surface using an adhesive or a polymeric melting process. In other words, any mechanism used to hold the cutting blade in place is in accordance with embodiments of the present disclosure is included herein.

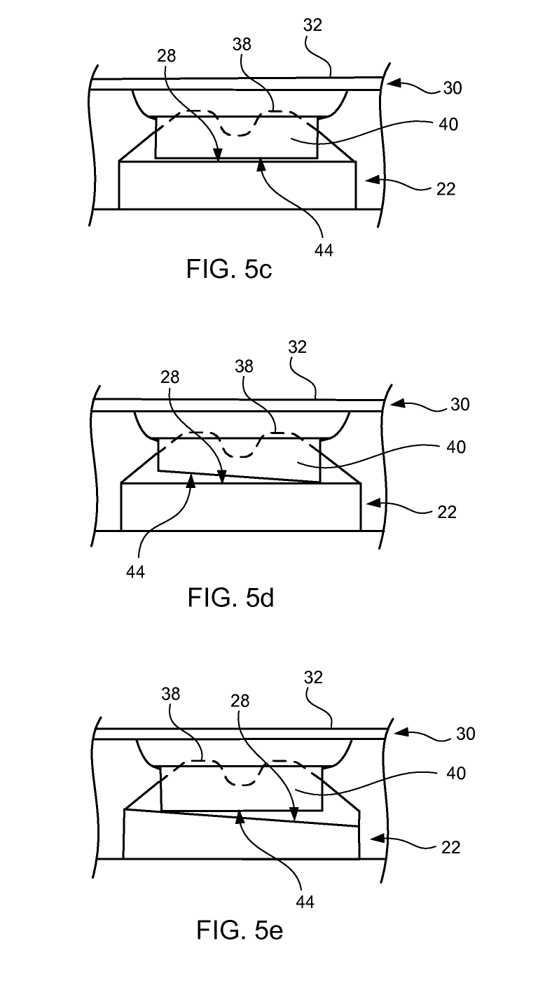

FIGS. 5a and 5b set forth two alternative embodiments of the disclosure as it relates to the cutting device 40, taken along sectional view C-C of FIG. 3. In both FIGS., the cutting device is attached at its attachment end 42 to the lid 30 with a mechanical grip 50 or other attachment mechanism. Assuming that the cutting surface (not shown in these FIGS., but shown in FIGS. 1 and 3) is generally flat in relation to the span of the exposed blade 44, the blade orientation shown in FIG. 5a will be generally parallel to the cutting surface when the lid is in the closed position. However, in FIG. 5b, again assuming that the cutting surface is generally flat in relation to the span of the exposed blade, the blade orientation will be angled with respect to the cutting surface when the lid is in the closed position. The angle 60 can be any angle that enables cutting of the retraction cord while reducing fraying of the retraction cord after cutting. Often, the exposed bladed is positioned at an angle ranging from 2° to 15° with respect to the cutting surface when the lid is in the closed position. It is notable that the exposed blade need not be the structure that is angled for this particular embodiment to function as described. For example, the cutting surface can be angled so that it is not flat on the cap body and the exposed bladed can be generally parallel to the upper surface of the lid. The feature that prevents some degree of fraying is the angled relationship between the exposed blade and the cutting surface, no matter how that angled relationship is achieved.

FIGS. 5c-5e depicts various embodiments of the exposed blade 44 of the cutting device 40 as it relates to the cutting surface 28 of the cap body 22 (when the lid 30 is in the closed position). Also shown is a retraction cord guide 38 for holding the retraction cord in place during the cutting process. FIG. 5c shows an embodiment where the exposed blade is parallel to the cutting surface, whereas FIGS. 5d and 5e both show embodiments where there is an angle relationship between the exposed blade and the cutting surface. FIG. 5d for example has an angled exposed blade and an essentially flat cutting surface. Conversely, FIG. 5e has an angled cutting surface and an essentially non-angled exposed blade with respect to the upper surface 32 of the lid. Exemplary angle relationships between the exposed blade and the cutting surface can be from about 2° to 15°, though angles outside of this range can also be appropriate for cutting the retraction cord while reducing fraying.

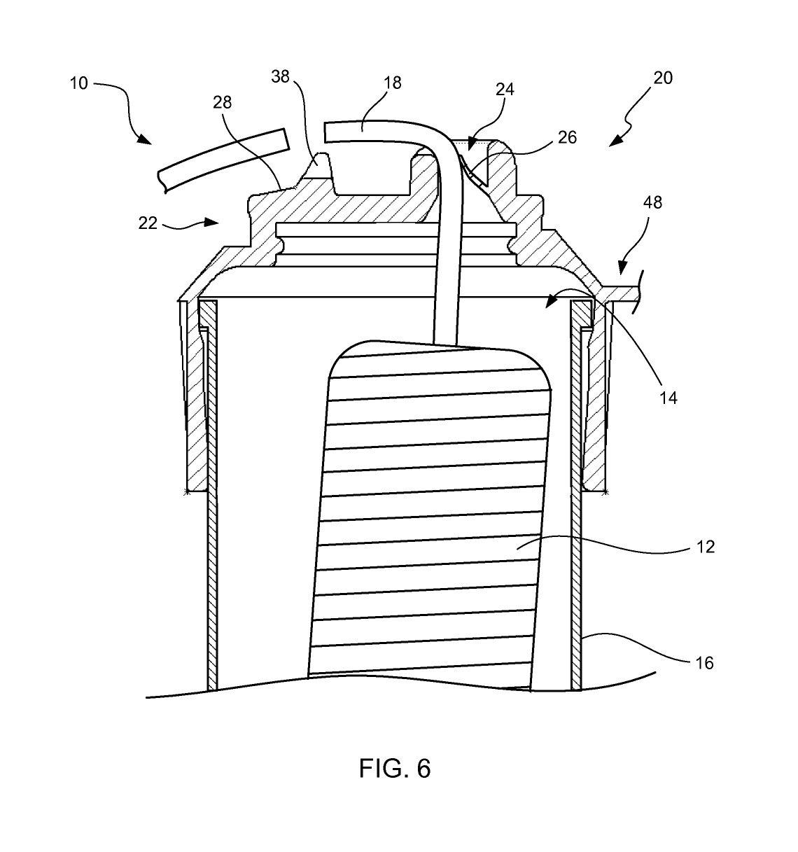

FIG. 6 provides a cross-sectional partial view of a retraction cord dispenser 10 similar to that shown in FIG. 1. In this FIG., the lid is not visible, but would extend outwardly from the flexible attachment arm 48, a portion of which is shown. The dispenser includes a container 12 for containing and dispensing retraction cord 16 through an open end 14 of the container. The system further includes a dispenser cap 20 with a cap body 22 having a narrow passage 24, a retention flap 26, a cutting surface 28 for cutting a dispensing end 18 of the retraction cord, and a retraction cord guide 38 for holding the retraction cord in place when cutting the dispensing end. FIG. 6 further provides a detailed view of the retention flap engaged with the retraction cord, preventing slippage of the dispensing end back into the container. Thus, the dispensing end, even though it is somewhat short, can be held in place for the user to dispense and cut additional retraction cord when desired.

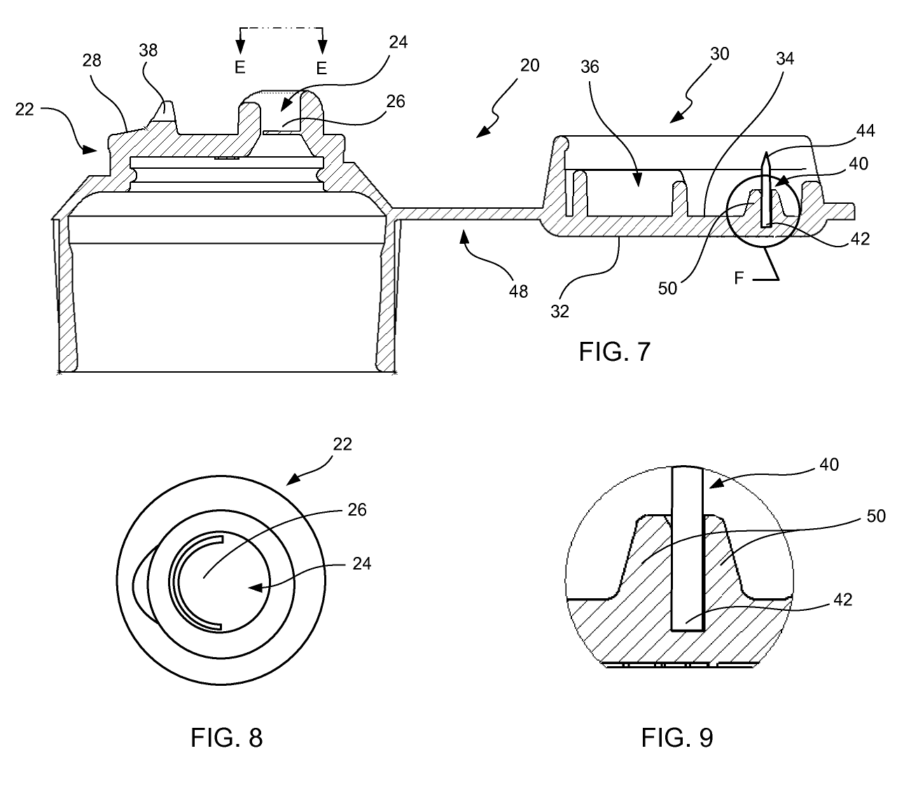

FIG. 7 is a cross-section view, taken along section D-D of FIG. 3, in accordance with embodiments of the present disclosure. The features shown in this view are similar to those described in FIGS. 1-6, and in fact use the same numerals described previously. Specifically, a cross-sectional view of a dispenser cap 20 is shown, which includes a cap body 22, a lid 30, and a flexible attachment arm 48 positioned therebetween. The cap body includes a narrow passage 24 for dispensing retraction cord, and a retention flap 26 for preventing dispensed retraction cord from falling or being pulled back through the narrow passage. A cutting surface 28 and a retraction cord guide 38 is also present as previously described. With specific reference to the lid, this portion of the dispenser cap includes an upper surface 32 and a lower surface 34. The lower surface supports a mechanical grip 50 which engages an attachment end 42 of a cutting device 40. The cutting device includes an exposed blade 44 that contacts or nearly contacts the cutting surface 28 of the cap body when the lid is closed over the cap body. As previously described, the blade can be positioned to match the angle of the cutting surface or can be offset at an angle with respect to the cutting surface to provide for cleaner cutting of the retraction cord to alleviate fraying. Also shown in this example is a cover 36 for covering the narrow passage when the lid is in the closed position.

FIG. 8 provides a top partial view of the cap body 22, taken along view E-E of FIG. 7. Specifically shown is a detail as it relates to the retention flap 26 within the narrow passage 24. Likewise, FIG. 9 provides a more detailed view of portion F of FIG. 7, and specifically a partial side cross-sectional view of a grip 50 as it engages an attachment end 42 of a cutting device 40.

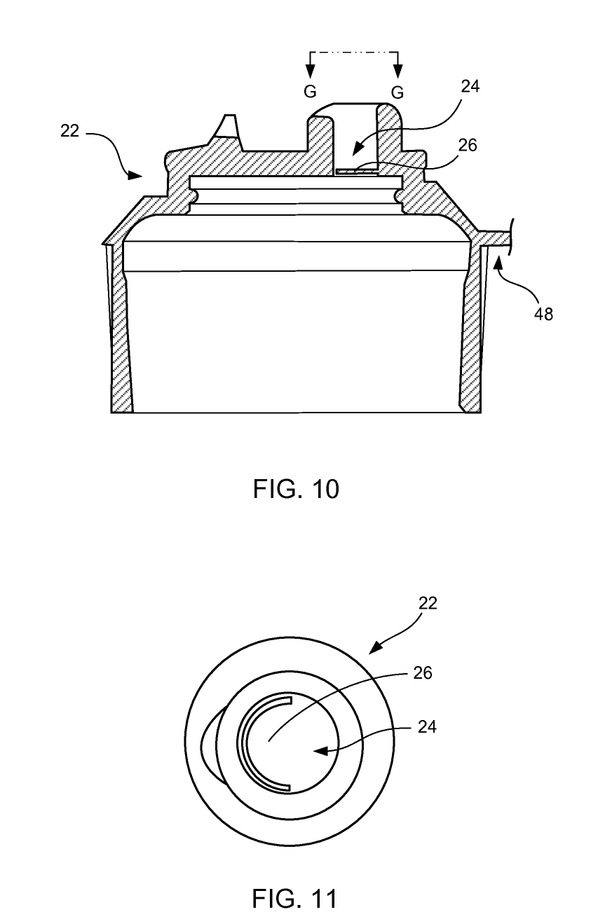

FIG. 10 provides a cross-sectional partial view of the view of the retraction cord dispenser of FIG. 7, except that the retention flap 26 of the cap body 22 is positioned at a different location within the narrow passage 24. Again, the lid portion of the dispenser cap is not shown, but would extend outwardly from the flexible attachment arm 48, a portion of which is shown. In further detail, FIG. 11 provides a top partial view of the cap body, taken along view G-G of FIG. 10. Specifically shown is a detail as it relates to the retention flap 26 within the narrow passage 24.

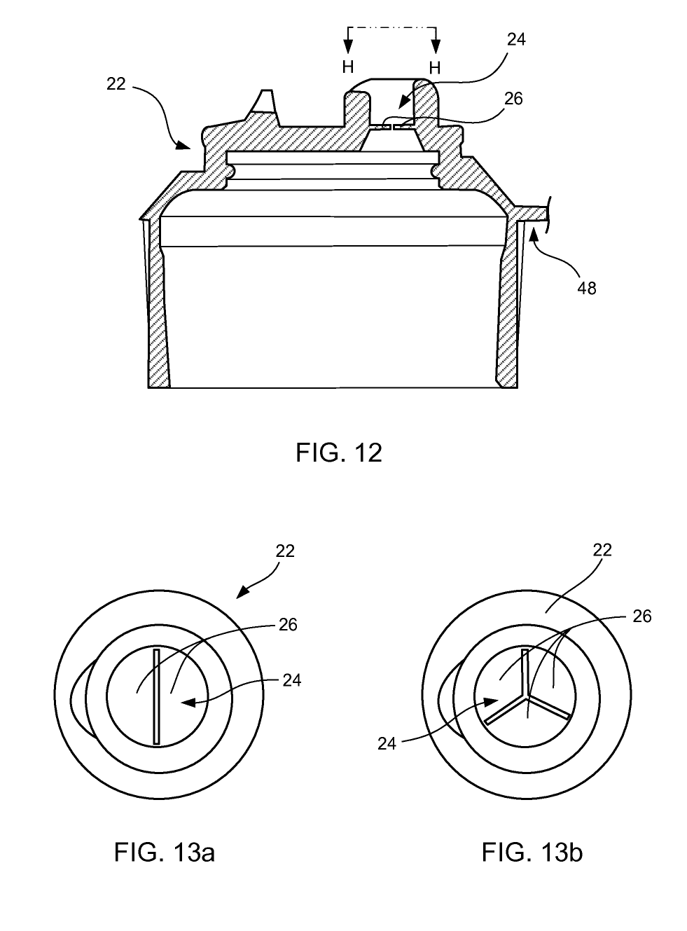

FIG. 12 provides a cross-sectional partial view of the view of the retraction cord dispenser of FIG. 7, except that the retention flap 26 of the cap body 22 has a different configuration within the narrow passage 24. Again, the lid portion of the dispenser cap is not shown, but would extend outwardly from the flexible attachment arm 48, a portion of which is shown. In further detail, FIGS. 13a and 13b provide two possible top partial views of the cap body, taken along view H-H of FIG. 12. Specifically shown is a detail as it relates to two retention flaps (FIG. 13a), or alternatively, three retention flaps (FIG. 13b). Any number or configuration of retention flaps, as well as any specific placement of retention flaps within the narrow passage are included as embodiments of the present disclosure, as long as they provide the function of improving the retention of dispensed retraction cord and preventing it from falling or being pulled back through the narrow passage after being dispensed.

It is to be understood that the above-referenced arrangements are only illustrative of the application for the principles of the present invention. Numerous modifications and alternative arrangements can be devised without departing from the spirit and scope of the present disclosure. Furthermore, while the disclosure has been shown in the drawings and described above with particularity and detail in connection with what is presently deemed to be the most practical embodiments(s), it will be apparent to those of ordinary skill in the art that numerous modifications can be made without departing from the principles and concepts herein as set forth in the claims.

What is claimed is:

1. A retraction cord dispenser, comprising:
a container with an open end and configured to hold retraction cord; and
a dispenser cap for attachment to the open end, the dispenser cap including a cap body with a narrow passage for dispensing retraction cord from the container, the narrow passage associated with a retention flap to prevent retraction cord from re-entering the container once it has been dispensed.

2. The retraction cord dispenser of claim 1, wherein dispenser cap includes a lid having an open position which exposes the narrow passage and a closed position which covers the narrow passage.

3. The retraction cord dispenser of claim 2, wherein the dispenser cap includes a cutting device configured to cut retraction cord when the lid is transitioned from the open position to the closed position.

4. The retraction cord dispenser of claim 3, wherein the cutting device includes an attachment end affixed to a lower surface of the lid, and an exposed blade.

5. The retraction cord dispenser of claim 4, wherein the cap body includes a cutting surface which contacts or nearly contacts the exposed blade when the lid is in the closed position.

6. The retraction cord dispenser of claim 5, wherein the exposed blade is positioned parallel to the cutting surface when the lid is in the closed position.

7. The retraction cord dispenser of claim 5, wherein the exposed blade is positioned at an angle ranging from 2° to 15° with respect to the cutting surface when the lid is in the closed position.

8. The retraction cord dispenser of claim 1, wherein the dispenser cap is attached to the open end of the container.

9. The retraction cord dispenser of claim 8, further comprising the retraction cord disposed within the container.

10. The retraction cord dispenser of claim 9, wherein an end of the retraction cord is dispensed through the narrow passage, and the retention flap is positioned to prevent the retraction cord from re-entering the container.

11. The retraction cord dispenser of claim 1, wherein the retention flap is a single flap configured to hold the retraction cord in place against a wall of the narrow passage.

12. The retraction cord dispenser of claim 1, wherein the retention flap includes multiple flaps configured to hold the retraction cord therebetween.

13. A method of dispensing and cutting retraction cord, comprising:
pulling retraction cord from a container through a narrow passage of a cap body;
cutting the retraction cord by closing a lid over the cap body, the lid being attached to the cap body and having an exposed blade affixed thereto that contacts or nearly contacts the cap body when the lid is in a closed configuration; and
engaging the retraction cord with a retention flap associated with the narrow passage, thereby preventing a dispensing end of the retraction cord from re-entering the container through the narrow passage.

14. The method of claim 13, wherein the retention flap is a single flap configured to hold the retraction cord in place against a wall of the narrow passage.

15. The method of claim 13, wherein the retention flap includes multiple flaps configured to hold the retraction cord therebetween.

16. The method of claim 13, wherein the step of cutting the retraction cord includes pushing the exposed blade through the retraction cord and against a cutting surface of the cap body.

17. The method of claim 16, wherein upon closing the lid over the cap body, the exposed blade is positioned parallel to the cutting surface.

18. The method of claim 16, wherein upon closing the lid over the cap body, the exposed blade is positioned at an angle ranging from 2° to 15° with respect to a cutting surface.

19. A retraction cord dispenser, comprising:
a container with an open end and configured to hold retraction cord; and
a dispenser cap for attachment to the open end, the dispenser cap, including:
a cap body having a narrow passage for dispensing retraction cord from the container and a cutting surface for supporting dispensed retraction cord for cutting, and
a lid having a cutting device attached thereto, the cutting device including an exposed blade configured to cut retraction cord when the cutting device is pressed against the cutting surface,
wherein the exposed blade is positioned at an angle ranging from 2° to 15° with respect to the cutting surface when the lid is pressed into a closed position over the cap body.

20. The retraction cord dispenser of claim 19, wherein the cap body further comprises a narrow passage including a retention flap to prevent retraction cord from re-entering the container once it has been dispensed.

21. The retraction cord dispenser of claim 19, wherein the exposed blade is parallel to an upper surface of the lid, and the cutting surface is angled at from 2° to 15° with respect to the exposed blade when the lid is in the closed position.

22. The retraction cord dispenser of claim 19, wherein the cutting surface is parallel to an upper surface of the lid when the lid is in the closed position, and the exposed blade is angled at from 2° to 15° with respect to the cutting surface when the lid is in the closed position.

23. The retraction cord dispenser of claim 19, wherein the cap body is attached to the lid by a flexible attachment arm.

24. The retraction cord dispenser of claim 19, wherein the dispenser cap is attached to the open end of the container and the retraction cord disposed within the container.
